(19) United States
(12) Patent Application Publication
(10) Pub. No.: US 2011/0223455 A1
(43) Pub. Date: Sep. 15, 2011

(54) LITHIUM-ION SECONDARY CELL

(76) Inventors: Naoki KIMURA, Hitachinaka-shi (JP); Takenori Ishizu, Hitachinaka-shi (JP); Yoshin Yagi, Hitachinaka-shi (JP); Toshiyuki Ariga, Hitachinaka-shi (JP); Takashi Eguchi, Nagaokakyo-shi (JP); Atsushi Ueda, Hitachi-shi (JP); Akihiko Maruyama, Hitachinaka-shi (JP); Mitsuru Koseki, Mito-shi (JP)

(21) Appl. No.: 13/029,153

(22) Filed: Feb. 17, 2011

(30) Foreign Application Priority Data
Mar. 9, 2010 (JP) 2010-052128

(51) Int. Cl. H01M 10/36

(52) U.S. Cl. 429/94

(57) ABSTRACT

A lithium-ion secondary cell includes a winding electrode assembly. The exposed area of the positive-electrode metal current collector body is formed at one end in a winding axis direction of the winding electrode assembly, and the exposed area of the negative-electrode metal current collector body is formed at another end in the winding axis direction of the winding electrode assembly; and the negative-electrode metal current collector body is a copper foil rolled to a thickness between 6 μm and 15 μm in which one or more of additive elements of Zr, Ag, Au, Pt, Cr, Cd, Sn, Sb, and Bi are added to Cu having a purity of equal to or greater than 99.9%, and the negative-electrode active material mix layer has a cavity volume ratio of between 30% and 60%.

### INCORPORATION BY REFERENCE

The disclosure of the following priority application is herein incorporated by reference: Japanese Patent Application No. 2010-052128 filed Mar. 9, 2010

### BACKGROUND OF THE INVENTION

1. Field of the Invention

The present invention relates to a lithium-ion secondary cell.

2. Description of Related Art

Power supply units such as lithium-ion secondary cells and capacitors are being increasingly developed so as to apply them to hybrid vehicles and the like.

In recent years, there are high expectations for practical use of hybrid vehicles and the like from the point of view of environmental issues such as carbon dioxide reduction, and accordingly there are remarkable improvements in cell performance and progressions in cell control technology.

A lithium-ion secondary cell is constituted mainly with electrodes (a positive electrode and a negative electrode), a separator, and electrolytic solution, and the separator holds the electrolytic solution and prevents short-circuit caused by the positive electrode and the negative electrode contacting each other. In general, an electrode is formed by coating active material mix on both sides of a metal foil while leaving metal foil exposed areas, and the electrode coated by the active material mix is heat-pressed, dehydrated, and then cut up into a predetermined size. When pressing, distortion such as wrinkles and ripple may occur on the electrode surface. Such distortion may cause distortion of the electrode such as electrode curvature after cutting.

The electrode curvature arises from difference in the rate of expansion or the amount of deformation due to difference in stress at heat-pressing between the active material mix layer coated area and the metal foil exposed area. In particular, a rate of expansion of the negative electrode, constituted with copper foil, is greater than that of the positive electrode, constituted with aluminium foil, and thus a large curvature may be generated at the negative electrode.

Therefore, a measure was taken to widely space the electrode and a separator across the width so as to permit distortion to some extent (referred to as measure (1)). In Japanese Laid Open Patent Publication No. H7-192726, a measure was taken to provide a metal foil with a plurality of discontinuous linear cuts so as to, even at the time of high-pressure pressing, cause deformation in the metal foil in accordance with the expansion of the active material mix layer (referred to as measure (2)).

### SUMMARY OF THE INVENTION

However, the above measure (1) results in reduction in volumetric efficiency, which obstructs improvement in cell performance. On the other hand, the above measure (2) requires an extra process for forming the cuts, which results in an increase in cost.

A lithium-ion secondary cell according to a first aspect of the present invention comprises: a winding electrode assembly that comprises: a positive-electrode plate in which a positive-electrode active material mix layer is disposed on both sides of a positive-electrode metal current collector body and an exposed area of the positive-electrode metal current collector body is provided along one of long sides of the positive-electrode plate; a negative-electrode plate in which a negative-electrode active material mix layer is disposed on both sides of a negative-electrode metal current collector body and an exposed area of the negative-electrode metal current collector body is provided along one of long sides of the negative-electrode plate; and a separator arranged between the positive-electrode plate and the negative-electrode plate, wherein: the exposed area of the positive-electrode metal current collector body is formed at one end in a winding axis direction of the winding electrode assembly, and the exposed area of the negative-electrode metal current collector body is formed at another end in the winding axis direction of the winding electrode assembly; and the negative-electrode metal current collector body is a copper foil rolled to a thickness between 6 μm and 15 μm in which one or more of additive elements of Zr, Ag, Au, Pt, Cr, Cd, Sn, Sb, and Bi are added to Cu having a purity of equal to or greater than 99.9%, and the negative-electrode active material mix layer has a cavity volume ratio of between 30% and 60%.

According to a second aspect of the present invention, in the lithium-ion secondary cell according to the first aspect, it is preferable that the exposed area of the positive-electrode metal current collector body is between 1 mm and 20 mm wide in the winding axis direction, and the exposed area of the negative-electrode metal current collector body is between 1 mm and 20 mm wide in the winding axis direction .

According to a third aspect of the present invention, in the lithium-ion secondary cell according to the first aspect, the negative-electrode metal current collector body may be formed by rolling oxygen-free copper.

According to a fourth aspect of the present invention, in the lithium-ion secondary cell according to the first aspect, the winding electrode assembly may be flat-shaped, and the flat-shaped winding electrode assembly is housed in a flat prismatic cell case.

According to a fifth aspect of the present invention, in the lithium-ion secondary cell according to the first aspect, the winding electrode assembly may be cylindrical-shaped, and the cylindrical-shaped winding electrode assembly is housed in a cylindrical cell case.

### BRIEF DESCRIPTION OF THE DRAWINGS

FIG. 1 is a perspective view showing an active material mix slurry production process for an electrode plate in the first embodiment of a lithium-ion secondary cell according to the present invention.

FIG. 2 is a plan view showing a process in which the active material mix slurry obtained in the process of FIG. 1 is coated on a metal current collector body and dehydrated.

FIG. 3 is a plan view showing a first cutting process in which the electrode plate obtained in the process of FIG. 2 is cut up.

FIG. 4 is a perspective view showing a heat-pressing process for the electrode plate obtained in the process of FIG. 3.

FIG. 5 is a plan view showing a second cutting process in which the electrode plate obtained in the process of FIG. 4 is cut up.

FIG. 6 is a view showing residual stress arising from the heat-pressing process of FIG. 4 and distortion in the electrode plate.

FIGS. 7A and 7B are tables showing the relationship between the material, fan rate, and cell direct-current resistance of the negative electrode plate with respect to examples of the first embodiment and comparison examples.

FIG. 8 is a table showing the relationship between the thickness of the negative-electrode metal current collector body, fan rate, and cell direct-current resistance with respect to examples of the first embodiment and comparison examples.

FIG. 9 is a table showing the relationship between the negative-electrode active material mix layer cavity volume ratio, fan rate, and cell direct-current resistance with respect to examples of the first embodiment and comparison examples.

FIG. 10 is a graph showing the relationship between the width of an exposed area of the negative-electrode metal current collector body and overlay position displacement of the exposed area of the negative-electrode metal current collector body of a winding electrode assembly with respect to examples of the firs embodiment and comparison examples.

FIG. 11 is a graph showing the relationship between the width of an exposed area of the positive electrode metal current collector body and overlay position displacement of the exposed area of the positive electrode metal current collector body of the winding electrode assembly with respect to examples of the first embodiment and comparison examples.

FIG. 12 is a perspective view showing the lithium-ion secondary cell according to the first embodiment.

FIG. 13 is an exploded perspective view of the lithium-ion secondary cell of FIG. 12.

FIG. 14 is a perspective view showing a winding electrode assembly of the lithium-ion secondary cell of FIG. 12.

FIG. 15 is a vertical sectional view showing the second embodiment of the lithium-ion secondary cell according to the present invention.

FIG. 16 is an exploded perspective view showing a discharge and charge unit of the second embodiment.

FIG. 17 is a perspective view showing a winding electrode assembly of the second embodiment.

### DESCRIPTION OF PREFERRED EMBODIMENTS

Embodiments of the lithium-ion secondary cell according to the present invention will now be explained with reference to the drawings. It is to be noted that the present invention is not limited to the details of the embodiments described below.

### First Embodiment

An electrode plate in the present embodiment will be produced through, for example, the following process.

[Producing Active Material Mix Slurry]

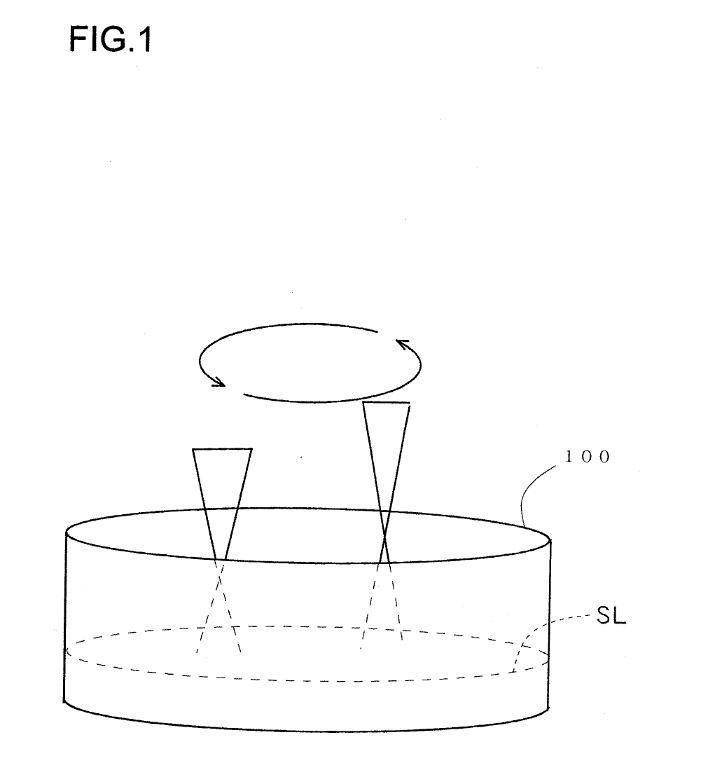

At first, as shown in FIG. 1, electrode materials are mixed in a mixer 100 so as to produce an active material mix (active material) slurry SL.

[Coating and Dehydrating Active Material Mix]

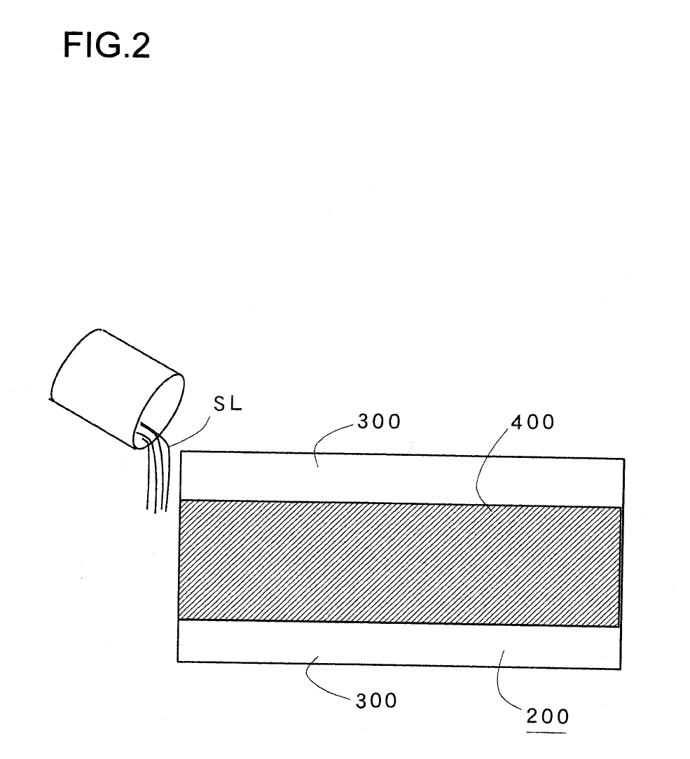

Next, as shown in FIG. 2, the active material mix slurry SL is coated in a predetermined width on both sides of a metal current collector body 200 so as to form an active material mix layer 400. At this time, exposed areas 300 on which the active material mix slurry SL is not coated are left at both ends (side ends) across the width of the metal current collector body 200. In addition, the active material mix slurry SL is dehydrated.

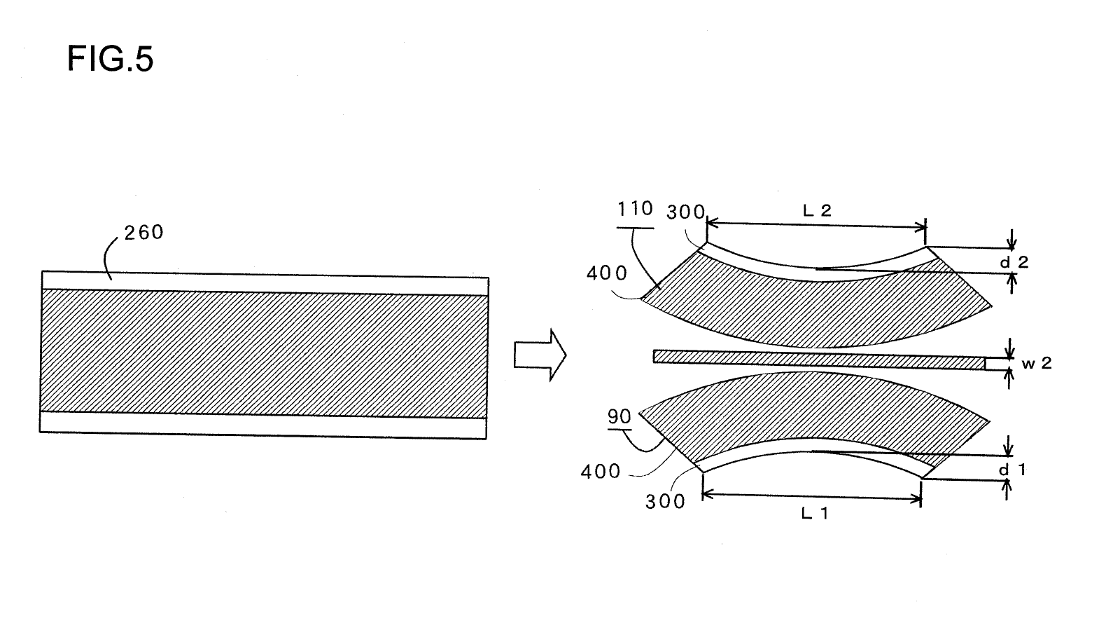

A plurality of electrode plates can be produced from one metal current collector body 200. When producing two electrode plates 90 and 110 (FIG. 5), the width of the active material mix layer 400 is set to double or more the width of the one electrode plate 90 or 110. It is to be noted that the active material mix layer 400 of an electrode plate (a positive plate 30) of a positive electrode is called a positive-electrode active material mix layer and the active material mix layer 400 of an electrode plate (a negative plate 40) of a negative electrode is called a negative-electrode active material mix layer. In other words, in the process of FIG. 2, a first electrode plate material 220 is produced, in which the plurality of electrode plates are integrated across the width.

[Cutting and Removing Ends]

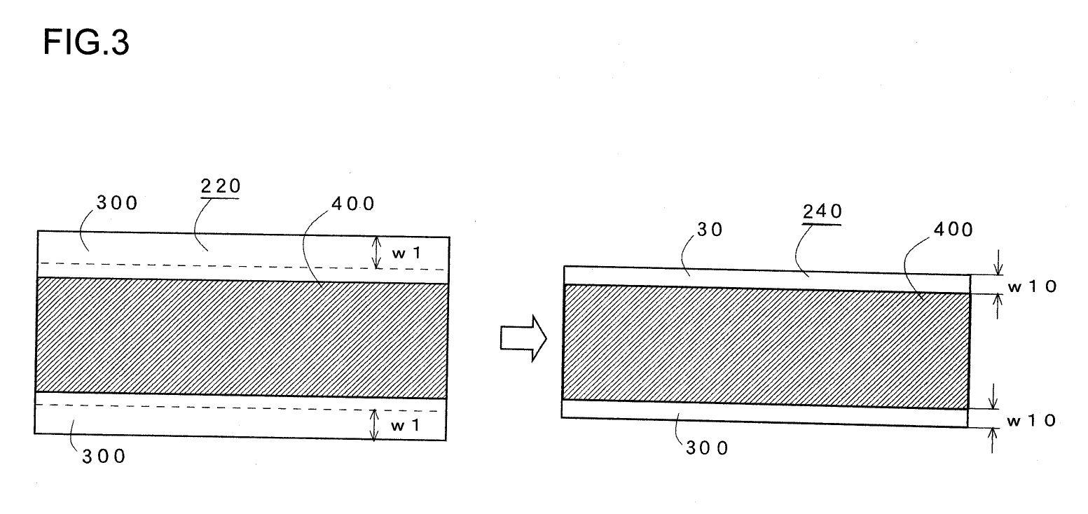

Next, as shown in FIG. 3, a predetermined width w1 of side end is cut and removed from each of the exposed areas 300 of the electrode plate material 220. As a result, a second electrode plate material 240, which includes each of the exposed areas 300 of a width w10, is produced.

[Heat-Pressing]

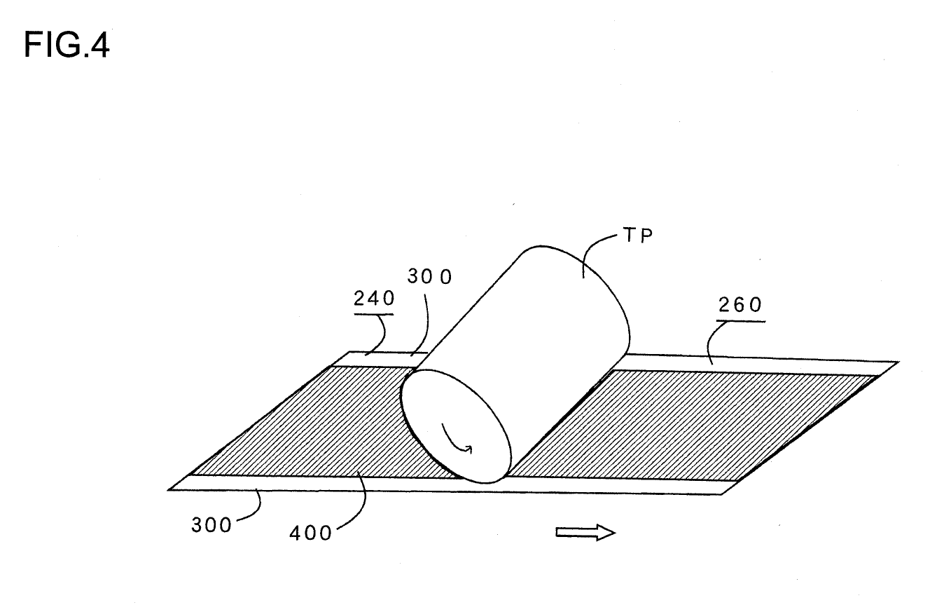

Next, as shown in FIG. 4, the second electrode plate material 240 is pressed using a heat-press tool TP so as to produce a third electrode plate material 260. At this time, the cavity volume ratio (the ratio of a cavity volume to the entire volume of the active material mix layer 400. Hereinafter, referred to as “CVR”.) of the active material mix layer 400 is controlled to a predetermined value.

[Cutting]

Next, as shown in FIG. 5, a part extending along a longitudinal direction with a predetermined width w2, which lies along the center in the width direction of the third electrode plate material 260, is cut and removed. As a result, the third electrode plate material 260 is divided widthwise into three, so that the two electrode plates 90 and 110 are formed from the both side ends. Distortion of curvature in the width direction may occur on the electrode plates 90 and 110, which are formed as above.

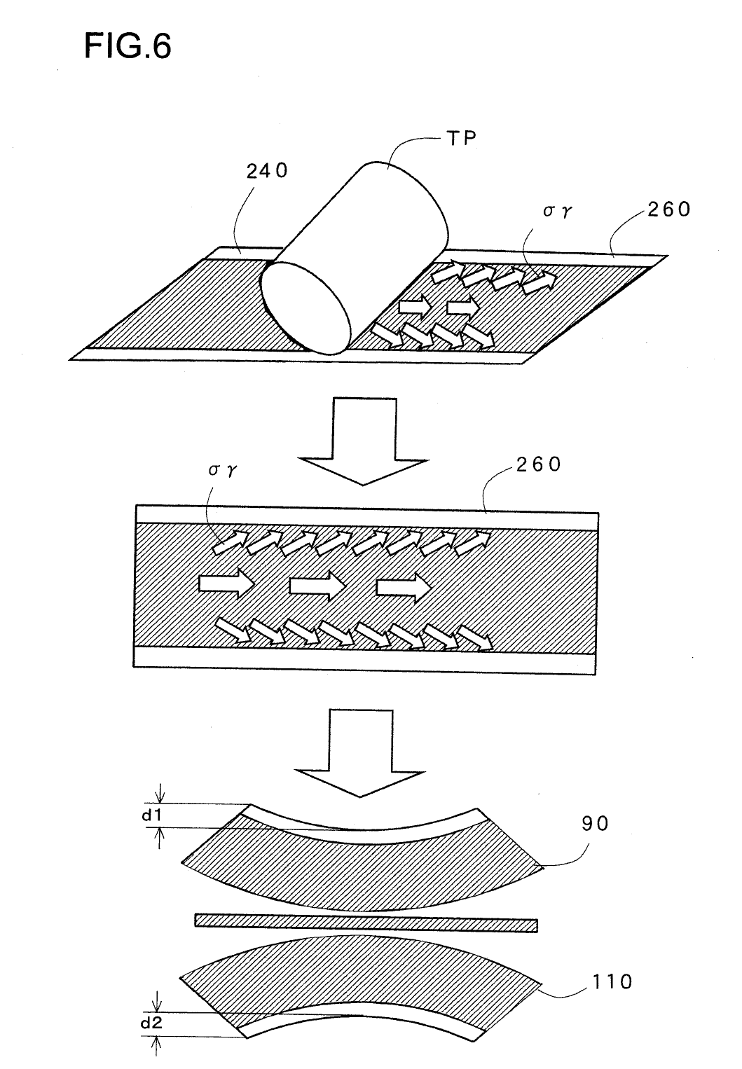

As shown by outline arrows of FIG. 6, the distortion in the electrode plates 90 and 110 is mainly caused by the heat-pressing process, and, in the third electrode plate material 260, a residual stress or, which is oriented obliquely from the center to the side edge direction, occurs as the rolling process progresses. The residual stress or remains in the third electrode plate material 260. Then, as shown in FIGS. 5 and 6, when the third electrode plate material 260 is cut into the electrode plates 90 and 110, distortion of curvature in the side edge direction occurs in the electrode plates 90 and 110 as the entire or a part of the residual stress or is released.

[Fan Rate]

The distortion in the electrode plates 90 and 110 shown in FIG. 6 is evaluated using a parameter such as a “fan rate” (hereinafter referred to as “FR”.). As shown in FIG. 5, the fan rate is given by a curvature depth d (in millimeter, “mm”, for example) in a reference length L (1 meter, for instance) at a side edge which is curved and recessed. In FIG. 5, the fan rates of the electrode plates 90 and 110 are FR1 (=depth d1) with the reference length L1 and FR2 (=depth d2) with the reference length L2, respectively.

[Winding Electrode Assembly]

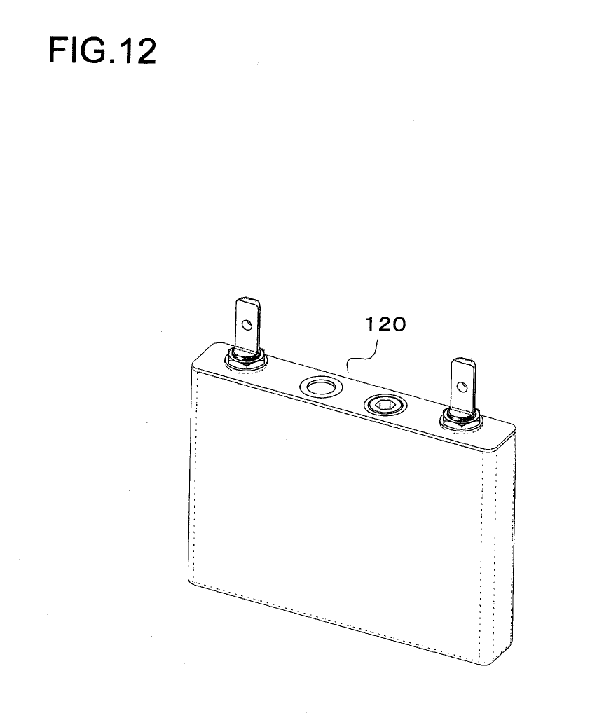

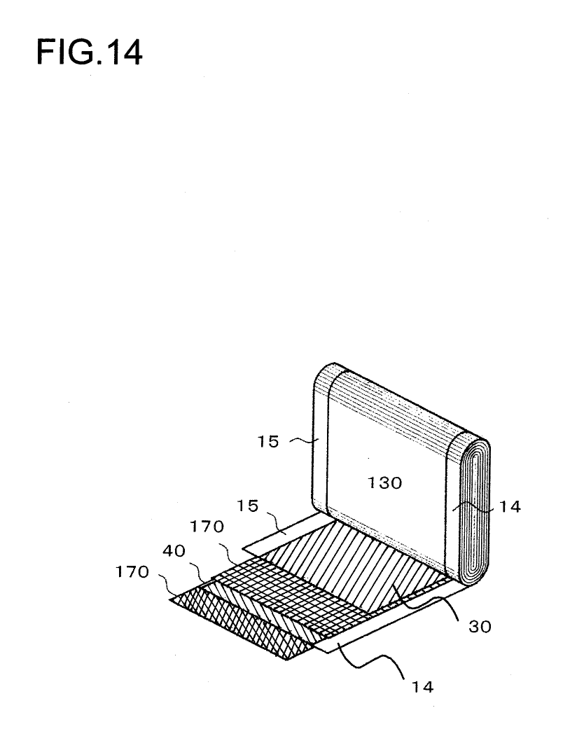

The present invention can be applied to a prismatic secondary cell 120 shown in FIG. 12. A winding electrode assembly 130 of the prismatic secondary cell 120 is shown in FIG. 14. The positive and negative electrode plates, which were produced in the above manner, i.e., a positive plate 30 and a negative plate 40, are wound through a separator 170 and the positive plate 30 is covered with the negative plate 40 so as to constitute the winding electrode assembly 130.

The positive plate 30 is wound so that an exposed area 15 (corresponding to the exposed are 300) is located at one end in the winding axis direction of the winding electrode assembly 130, and the negative plate 40 is wound so that an exposed area 14 (corresponding to the exposed area 300.) is located at the other end in the winding axis direction of the winding electrode assembly 130. As a result, one of the positive electrode exposed area 15 and the negative electrode exposed area 14 is provided at one of the both ends of the winding axis of the winding electrode assembly 130 while the other of the positive electrode exposed area 15 and the negative electrode exposed area 14 is provided at the other of the both ends of the winding axis.

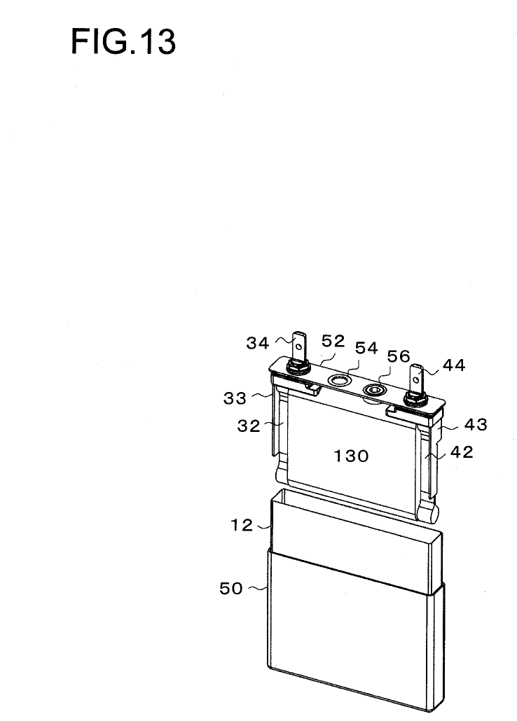

As shown in FIG. 13, the lithium-ion secondary cell is constituted by covering the winding electrode assembly 130 with an insulation bag 12 and housing them in a cell case 50.

In the winding electrode assembly 130, aluminium positive and negative electrode current collector leads 32 and 42 are ultrasonic welded to the exposed areas 15 and 14 of the positive and negative plates 30 and 40, respectively, and the current collector leads 32 and 42 are connected through a positive electrode connecting plate 33 and a negative electrode connecting plate 43 to a positive terminal 34 and a negative terminal 44 mounted to a cell cover 52, respectively. By doing this, the winding electrode assembly 130 is held by the cell cover 52, thereby enabling charge and discharge via the positive and negative terminals 34 and 44.

The cell cover 52 is provided with an electrolyte filling inlet 54 for inletting electrolytic solution (for example, 1MLiPF6/EC:EMC=1:3), and further provided with a gas burst valve 56 for venting pressure when an internal pressure rises abnormally. The electrolyte filling inlet 54 is covered by laser welding after the electrolytic solution is inlet. The cell cover 52 is laser welded to the cell case 50 and thus the cell case 50 is sealed.

A metal current collector body (a positive electrode metal current collector body) of the positive plate 30 includes lithium transition metal complex oxide, and the negative plate 40 occludes and releases Li.

The present invention relates to a lithium-ion secondary cell, mainly to the negative plate 40 thereof, and a metal current collector body (a negative-electrode metal current collector body) 200 of the negative plate 40 must contain not less than 99.9% of Cu and be add with at least one of elements, Zr, Ag, Au, Pt, Cr, Cd, Sn, Sb, and Bi, which are for improving strength.

The metal current collector body 200 with such composition has a sufficient tensile strength, so that a length change in the tensile direction was less than 5% when a “deformation test” was conducted by giving a tensile load (for instance, 1N) for 12 hours in environments of 25 degrees Celsius or more and 15 degrees Celsius or less. As a result, residual stress occurring in the heat-pressing process can be reduced, and deformation (curvature) of the electrode plates 90 and 110 after the cutting process can be reduced.

Also in the negative plate 40 using the metal current collector body 200 with the above composition, deformation of the electrode plates 90 and 110 may become great depending on the cavity volume ratio CVR of the active material mix layer 400 in the heat-pressing process. More specifically, with the cavity volume ratio of less than 30% in the heat-pressing process, the curvature increased remarkably and the electric resistance increased. On the other hand, with the cavity volume ratio of over 60%, the electric resistance increased while the curvature was prevented.

In addition, also in the negative plate 40 using the metal current collector body 200 with the above composition, the curvature increased remarkably if the width w10 of the exposed area 14 is greater than 20 mm.

In addition, even in the metal current collector body 200 with the above composition, if the metal current collector body 200 is less than 6 μm thick, the curvature increased remarkably. On the other hand, if the metal current collector body 200 is 15 μm thick or greater, the cell weight and volume increased and the cell properties decreased with an increase in the thickness while the deformation prevention effect was constant.

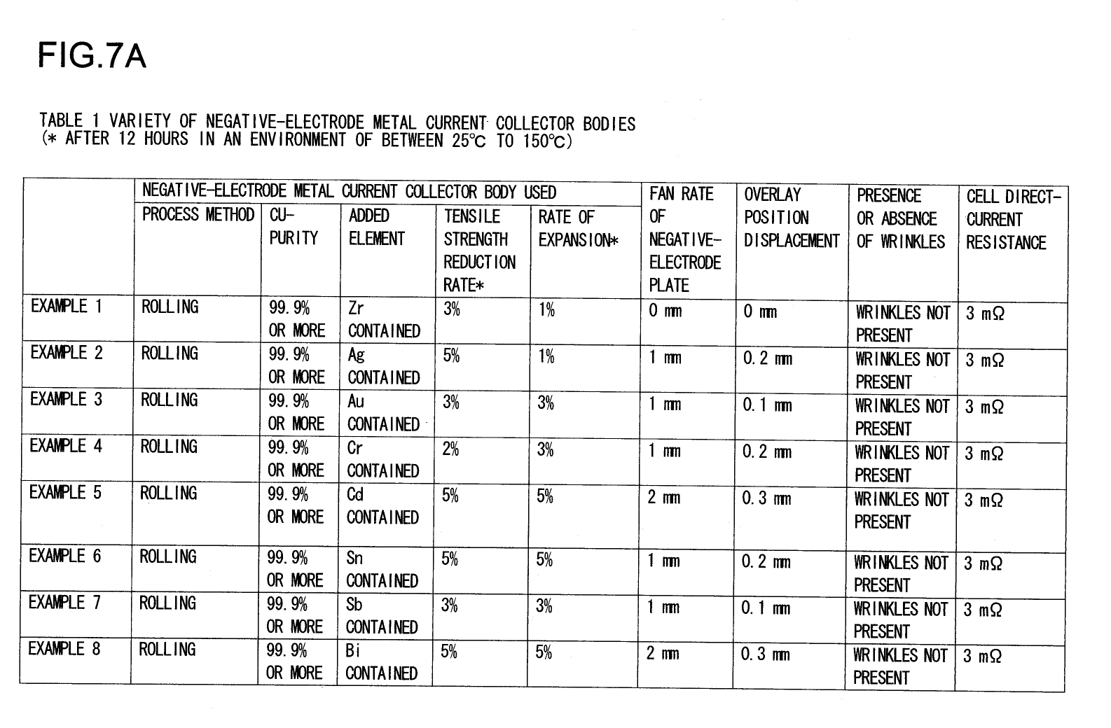

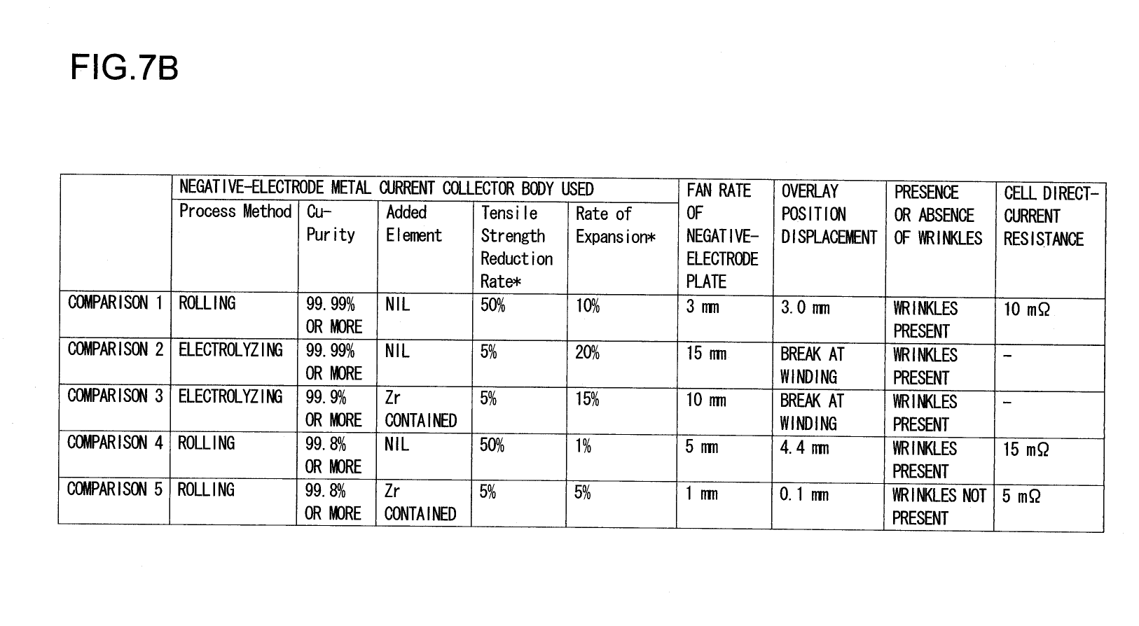

The result of the above deformation test was evaluated by measuring the fan rate FR after the test with respect to the negative plate 40. At this time, the acceptance criterion was the fan rate FR=d=2 mm or less to the reference length L=1 m. If the fan rate FR =d>2 mm, the winding displacement amount of the winding electrode assembly 130 extremely increases, which may result in a cell failure. In FIG. 7A to FIG. 9, the winding displacement amount is represented by an overlay position displacement at the exposed area 14 of the metal current collector body 200 in the winding electrode assembly 130.

In the winding electrode assembly 130 using the negative plate 40 produced with the above conditions, the exposed area 14 of the metal current collector body 200 in the negative plate 40 has few wrinkles, improved weldability, and no increase in electric resistance due to the wrinkles.

The lithium transition metal complex oxide can be used for the active material mix (positive-electrode active material) in the positive plate 30, and, as for positive-electrode active materials such as lithium nickel oxide and lithium cobalt oxide, which are lithium transition metal complex oxide, Ni or Co may partly be replaced with one or more types of transition metals.

For the active material mix (negative-electrode active material) in the negative plate 40, a carbonaceous material in which Lii such as non-graphitizable carbon, natural graphite, artificial graphite, and graphitized carbon can be occluded and released can be used. In general, the positive-electrode active materials and the negative-electrode active materials include a binding agent, a conductive agent, and the like other than the active material, and advantageous effects of the present invention remain intact regardless of the type and amount of those agents.

The electrolytic solution may be organic electrolytic solution in which lithium salt selected from at least one of, for example, LiPF₆, LiBF₄, LiClO₄, LiN (C₂F₅SO₂)₂, and the like is dissolved in a nonaqueous solvent selected from at least one of, for example, ethylene carbonate, propylene carbonate, butylene carbonate, dimethyl carbonate, ethyl methyl carbonate, diethyl carbonate, gamma butyrolactone, gamma valerolactone, methyl acetate, ethyl acetate, methylpropionate, tetrahydrofuran, 2-methyltetrahydrofuran, 1,2-dimethoxyethane, 1-ethoxy-2-methoxyethane, 3-methyltetrahydrofuran, 1,2-dioxane, 1,3-dioxane, 1,4-dioxane, 1,3-dioxolan, 2-methyl-1,3-dioxolan, 4-methyl-1,3-dioxolan, and the like. Alternatively, a known electrolyte used in a cell, for instance, a lithium-ion conductive solid electrolyte or gelled electrolyte, or molten salt may be used.

As the separator 170, a general separator constituted with polyethylene, polypropylene, or the like, or a separator with an inorganic matter such as alumina or silica contained therein or coated thereon may be used.

In Table 1 of FIGS. 7A and 7B, the results of the above deformation test is compared between the examples 1 to 8 based upon the present embodiment and the comparison examples 1 to 5. The conditions are as shown in the following (1) to (11).

(1) The metal current collector body 200 of the negative plate 40 is a copper foil of 10 μm thick, and the elements, Zr, Ag, Au, Cr, Cd, Sn, Sb, and Bi were added for improving strength as described above in the examples 1 to 8, respectively. On the other hand, no element was added in the comparison examples 1, 2, and 4 and Zr was added for improving strength in the comparison examples 3 and 5. The purity of Cu was as low as 99.8% in the comparison example 5.

(2) While the negative-electrode metal current collector body 200 was produced by means of the above heat-pressing in the comparison examples 1, 4, and 5, similarly in the examples 1 to 8, that was electrolytically produced in the comparison examples 2 and 3.

(3) The negative-electrode active material mix layer is 60 mm wide.

(4) The exposed area 14 of the negative-electrode metal current collector body 200 is 16 mm wide.

(5) The negative-electrode active material mix is produced as follows.

Amorphous carbon, graphite as a conductive agent, polyvinylidene fluoride as a binding agent were mixed in a weight ratio of the negative-electrode active material:conductive agent:binding agent=90:5:5 so as to obtain the negative-electrode active material mix slurry SL, and the resultant active material mix slurry SL was coated on the both sides of the negative-electrode metal current collector body 200.

(6) In the heat-pressing process, the negative-electrode metal current collector body 200 was roll-formed with a load of 15 kg/cm² by heat-pressing at 15 degrees Celsius.

(7) The load of heat-pressing was adjusted so as to set the cavity volume ratio of the negative-electrode active material mix to 35%.

(8) The metal current collector body of the positive plate 30 is an aluminium foil of 20 μm thick.

(9) The positive-electrode active material mix layer is 58 mm wide.

(10) The exposed area 15 of the metal current collector body 200 is 14 mm wide.

(11) The positive-electrode active material mix is produced as follows. A positive-electrode active material LiCoO₂, graphite as a conductive agent, polyvinylidene fluoride as a binding agent were mixed in a weight ratio of the positive-electrode active material:conductive agent:binding agent=85:10:5 so as to obtain the positive-electrode active material mix slurry SL, and the resultant active material mix slurry SL was coated on the both sides of the metal current collector body 200.

According to the deformation test results, the examples 1 to 8 each had the fan rate FR of 0 mm to 2 mm, thus meeting the criterion of 2 mm or less. The comparison examples 1 and 4 had the fan rate FR of as large as 3 mm and 5 mm, respectively. On the other hand, in the comparison examples 2 and 3, a break occurred on the negative-electrode plate 40 when they were being rolled in producing the winding electrode assembly 130. In addition, in the comparison examples 1 to 4, the exposed area 14 had wrinkles.

In addition, in order to evaluate the quality of the winding electrode assembly, the exposed area 14 in the negative-electrode metal current collector body 200 was checked for overlay position displacement and wrinkles. As the result, the comparison example 5 had the fan rate of as small of 1 mm and no wrinkle occurred but had a cell direct-current resistance of as high as 5 mΩ. In the comparison examples 1 and 4, cell direct-current resistances were as high as 10 mΩ and 15 mΩ, respectively. In each of the examples 1 to 8, the cell direct-current resistance was as low as 3 mΩ.

Table 1 shows that the overlay position displacement of the exposed area 14 of the negative-electrode metal current collector body 200 of the winding electrode assembly 130 is equal to or less than 0.3 mm if the fan rate of the negative plate 40 is equal to or less than 2 mm, and the overlay position displacement increases remarkably if the fan rate is equal to or greater than 3 mm. In addition, if the fan rate is equal to or less than 2 mm, an electrode roll can be produced without wrinkles on the exposed area 14 of the negative-electrode metal current collector body of the winding electrode assembly 130.

With a larger overlay position displacement, the separator 170 may not be positioned between the positive plate 30 and the exposed area 14 of the negative plate 40, or between the negative plate 40 and the exposed area 15 of the positive plate 30, and thus, one of the exposed areas 15 and 14 of the positive and negative electrode plates 30 and 40 may short-circuit to the positive or negative plate 40 or 30 of the opposite electrode.

In addition, if the active material mix layer 400 of the negative electrode does not cover the active material mix layer 400 of the positive electrode due to the overlay position displacement, overvoltage may occur at the end (the negative plate 40 adjacent to the positive plate 30) of the negative-electrode active material mix layer 400, which may result in dendrite precipitation or the like.

If the overlay position displacement is to be permitted, it is required to arrange an side edge of the positive or negative electrode plate 30 or 40 at which the exposed area 15 or 14 is not present further inward than the side edge of the separator 170 so as to ensure insulation between one of the exposed areas 15 and 14 of the positive and negative electrode plates 30 and 40 and the side edge of the positive and negative electrode plates 30 and 40 or the opposite pole, thereby resulting in less freedom of design and difficulty in improving cell properties. In other words, the overlay position displacement becomes a serious obstacle to improvement in cell performance.

Since the comparison examples 1 and 4 have a great overlay position displacement, it was required to increase the distance between the end of the negative-electrode active material mix layer 400 closer to the exposed area 15 of the positive-electrode metal current collector body 200 and the end of the separator 170 which covers the negative plate 40 closer to the exposed area 15 of the positive-electrode metal current collector body 200 in the winding axis direction approximately 30-fold that in each of the examples 1 to 8. As a result, the facing areas of the positive and negative plates 30 and 40 were reduced and the cell direct-current resistance was increased.

In the comparison example 5, while the negative-electrode metal current collector body 200 was produced by heat-pressing and Zr was added to the metal current collector body 200 as an added element, the metal current collector body 200 had a Cu purity of as low as 99.8% or greater, which is low in quality. Accordingly, the cell direct-current resistance is high. Therefore, the negative-electrode metal current collector body 200 is required to have a Cu purity of 99.9%. Commercial materials with such quality include oxygen-free copper.

In the comparison example 1, while the negative-electrode metal current collector body 200 was produced by heat-pressing and the metal current collector body 200 had a Cu purity of as high as 99.99% or greater, which is high in quality, no element was added to the metal current collector body 200. As a result, the fan rate was as great as 3 mm and the cell direct-current resistance was as high as 10 mΩ.

On the other hand, in the examples 1 to 8, although the negative-electrode metal current collector body 200 had a Cu purity of 99.9% or greater, which is lower than in the comparison example 1, since Zr, Ag, Au, Cr, Cd, Sn, Sb, and Bi were added as added elements, respectively, the fan rate and cell direct-current resistance were as low as 2 mm or less and 3 mΩ, respectively. It is to be noted that Pt may as well be used as an added element.

In other words, the fan rate and cell direct-current resistance can be improved by containing any one or more of those added elements.

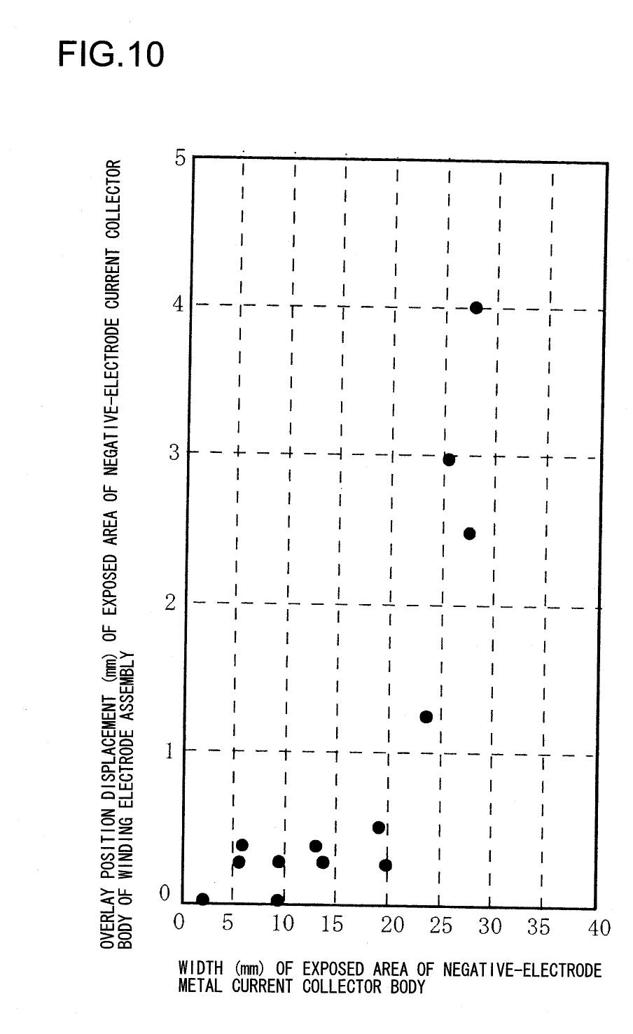

FIG. 10 shows the relationship between the width w10 of the exposed area 14 of the metal current collector body 200 of the negative plate 40 and the overlay position displacement thereof According to FIG. 10, when the w10>20 mm, the overlay position displacement increases sharply from a value of less than 1 mm, and, when the w10=28 mm, it reaches 4 mm.

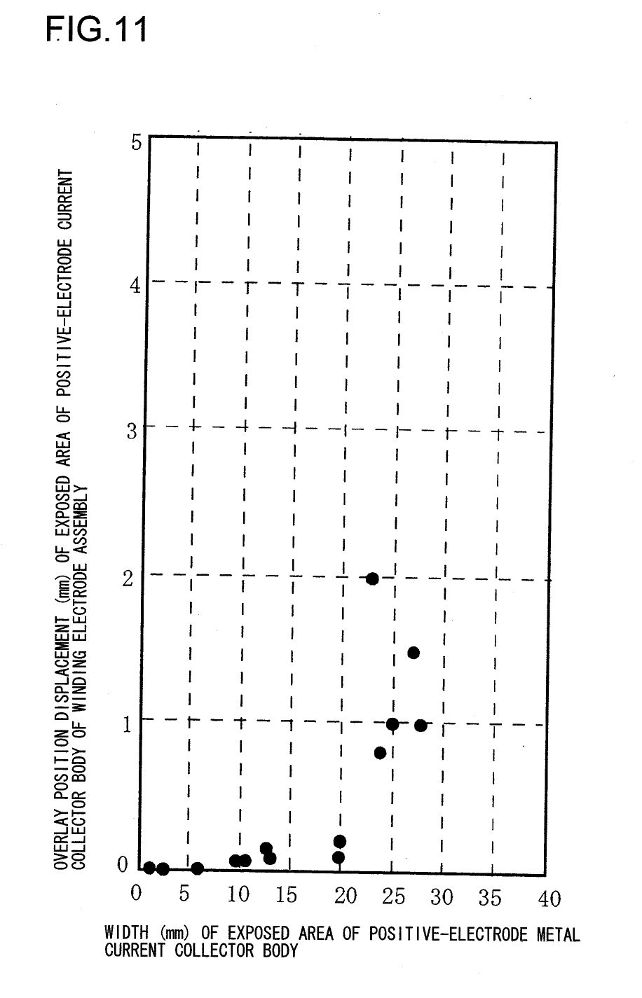

FIG. 11 shows the relationship between the width w10 of the exposed area 15 of the metal current collector body 200 of the positive plate 30 and the overlay position displacement thereof According to FIG. 11, when w10>20 mm, the overlay position displacement increases sharply from a value of less than 0.5 mm and reaches 2 mm at maximum.

According to FIGS. 10 and 11, the width w10 of the metal current collector body 200 is required to be equal to or less than 20 mm and, due to restrictions such as the connecting area of the positive and negative electrode current collector leads 32 and 42 and coating tolerance, the w10 should be equal to or greater than 1 mm.

In other words, the positive and negative plates 30 and 40 which are practical with reduced overlay position displacement can be achieved by giving 1 mm≦w10≦20 mm.

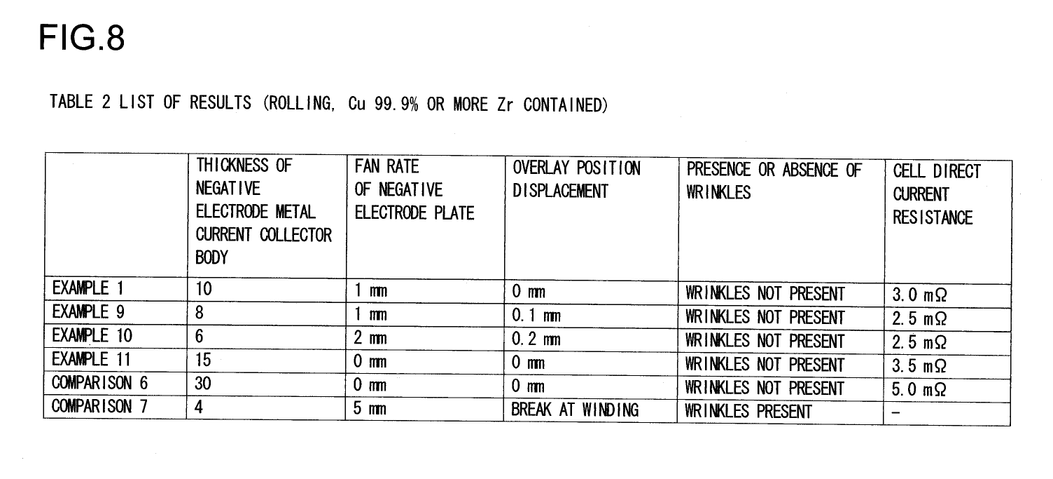

In Table 2 of FIG. 8, the relationships between the thickness of the metal current collector body 200 of the negative plate 40, the fan rate FR, and the cell direct-current resistance are compared with respect to the examples 1 and 9 to 11 based upon the present embodiment and the comparison examples 6 and 7. In the examples 1 and 9 to 11, the metal current collector body 200 ranges from 6 μm to 15 μm thick and, in the comparison examples 6 and 7, it is 30 μm thick or 4 μm thick, respectively. According to Table 2, in each of the practical examples 1 and 9 to 11, the fan rate was equal to or less than 2 mm.

On the other hand, in the comparison example 7, the fan rate was as great as 5 mm and a break occurred on the negative plate 40 when it was being rolled in producing the winding electrode assembly 130.

In the comparison example 6, although the metal current collector body 200 was over 15 μm thick, i.e., 30 μm thick, and had the fan rate of 0 mm and no overlay position displacement, the cell direct-current resistance was 5.0 mΩ, which was higher than 3.5 mΩ or less in the examples 1 and 9 to 11. In other words, since, with an increase in thickness, the area of the active material is reduced, the resistance increases, and the cell weight increases, the cell properties are reduced. As a result, the metal current collector body 200 of the negative plate 40 should be between 6 μm and 15 μm thick.

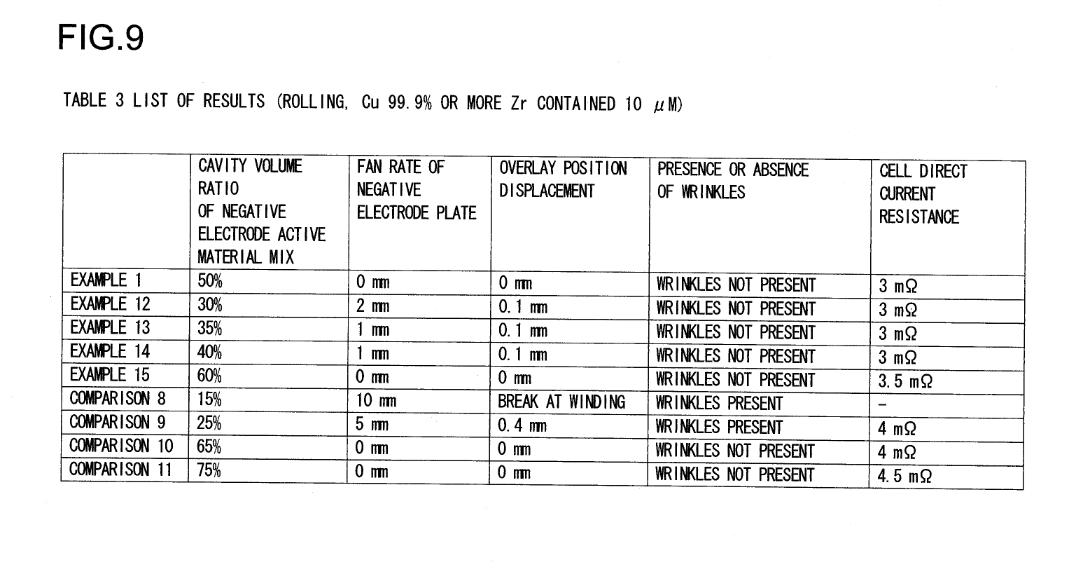

In Table 3 of FIG. 9, the relationships between the cavity volume ratio CVR at the active material mix layer 400 of the negative plate 40, the fan rate FR, and the cell direct-current resistance are compared with respect to the examples 1 and 12 to 15 based upon the present embodiment and the comparison examples 8 to 11.

In the examples 1 and 12 to 15, the CVR≧30%, the fan rate FR≦2 mm, and the overlay position displacement is equal to or less than 0.1 mm. On the other hand, in the comparison examples 8 and 9, the CRV is as low as 15% or 25%, respectively, the fan rate FR is as great as 10 mm or 5 mm, respectively, and a break occurs when being rolled or the overlay position displacement is as great as 0.4 mm. In other words, if the cavity volume ratio CVR is less than 30%, the fan rate FR remarkably increases, thereby interfering with the rolling.

In addition, while the cell direct-current resistance was equal to or less than 3.5 mu in the examples 1 and 12 to 15, the cell direct-current resistance was 4 mΩ to 4.5 mΩ in the comparison examples 9 to 11. In other words, in the comparison examples, due to an increase in the overlay position displacement, the reaction area decreases, and the cell direct-current resistance increases. It is to be noted that, in the comparison example 8, a break occurred and thus the resistance could not measured.

In the comparison examples 10 and 11, while the cavity volume ratio CVR>60% and each of the fan rate and overlay position displacement was zero, the resistance was high because an impact of the reduction in the active material amount was greater than a low-resistance effect due to the increase in the reaction area. As a result, the active material mix layer 400 of the negative plate 40 should have the cavity volume ratio CVR between 30% and 60%.

As seen from the above, the present embodiment is achieved by improvement with less influence on the processing cost, such as by improvement in the material of the negative-electrode metal current collector body 200, setting of coating dimensions of the active material mix layer 400, and the like, and thus distortion in the electrodes can be prevented without increasing the processing cost of the electrodes. Then, without reducing the cell performance, curvature in the electrodes can be reduced and cell failure due to winding displacement of the winding electrode assembly 130 can be prevented.

In addition, the width w10 of the exposed area 14 of the metal current collector body 200, the thickness of the negative plate 40 of the metal current collector body 200, and the cavity volume ratio CVR of the active material mix layer 400 are defined so as to reduce the curvature in the negative plate 40 and remarkably reduce the winding displacement amount during rolling, thereby preventing poor connection and lithium dendrite precipitation in the positive and negative electrode plates 30 and 40.

### Second Embodiment

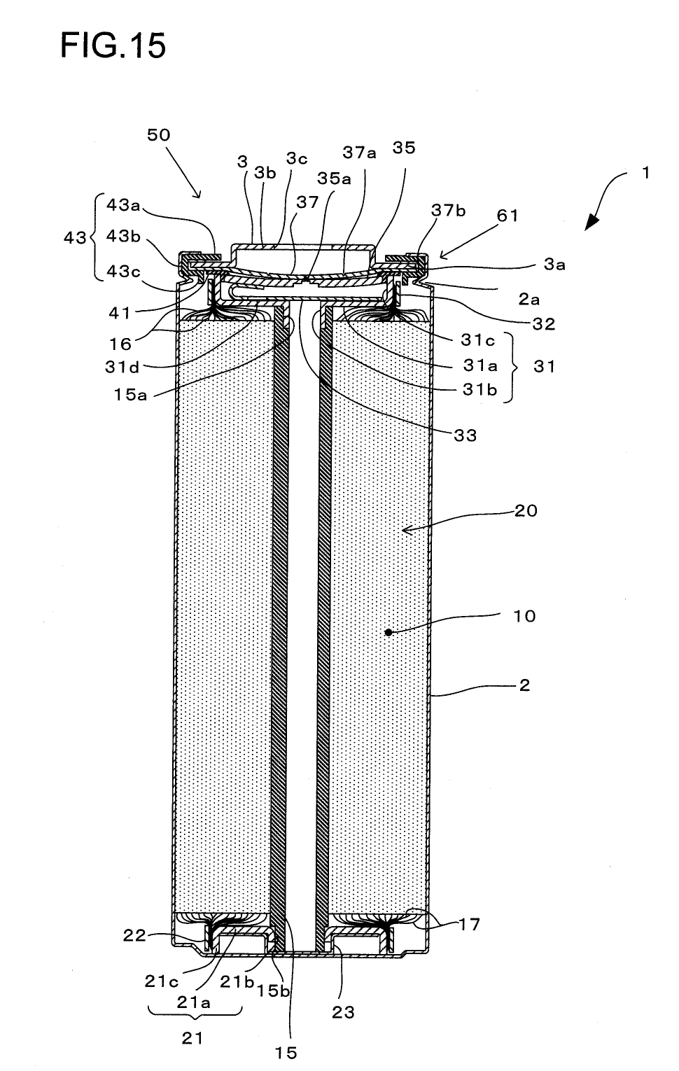

The second embodiment of a lithium-ion secondary cell according to the present invention will now be explained with reference to FIG. 15 to FIG. 17. It is to be noted that parts in the figures that are identical or corresponding to those in the first embodiment are designated by the same reference numerals, and their description will be curtailed.

A sealed cell 1 is of a cylindrical shape, having dimensions of, for instance, an outer diameter of 40 mm and a height of 100 mm. This cylindrical secondary cell 1 is constituted by housing a discharge and charge unit 20 in a bottomed cylindrical cell case 2 whose opening is sealed with a sealing cover 50. At first, the cell case 2 and the discharge and charge unit 20 will be explained, and next, the sealing cover 50 will be explained.

(Cell Case 2)

A crimp 61 is formed on a case opening end 2a side of the bottomed cylindrical cell case 2. The sealing cover 50 is fixed to the cell case 2 through an insulating gasket 43 using the crimp 61 so as to secure the sealing performance of the sealed cell 1, which contains nonaqueous electrolytic solution.

(Discharge and Charge Unit 20)

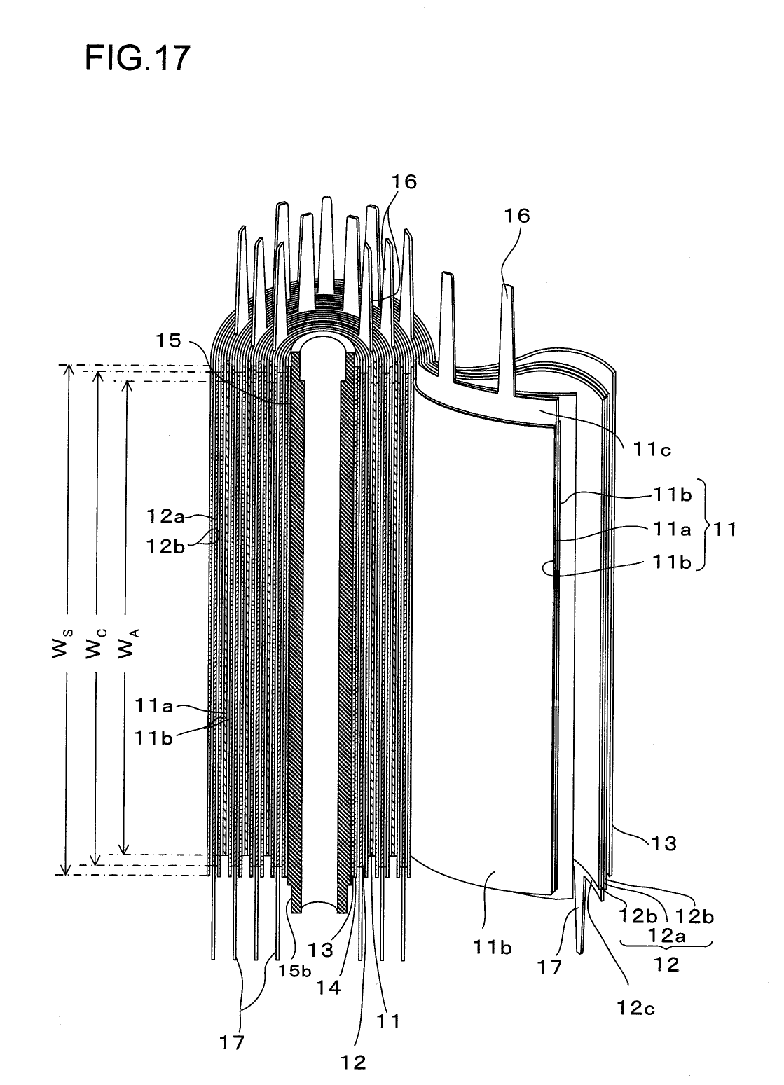

The discharge and charge unit 20 is constituted as a unit by integrating an electrode assembly 10, a positive-electrode current collecting member 31, and a negative-electrode current collecting member 21 as explained below. The electrode assembly 10 includes a winding core 15 at its center, and a positive electrode, a negative electrode, and a separator are wound around the winding core 15. FIG. 17 is a perspective view showing the structure of the electrode assembly 10 in detail, a part of which is a cross-sectional view. As illustrated in FIG. 17, the electrode assembly 10 has a structure in which a positive electrode 11, a negative electrode 12, and first and second separators 13 and 14 are wound on the outer circumference of the winding core 15.

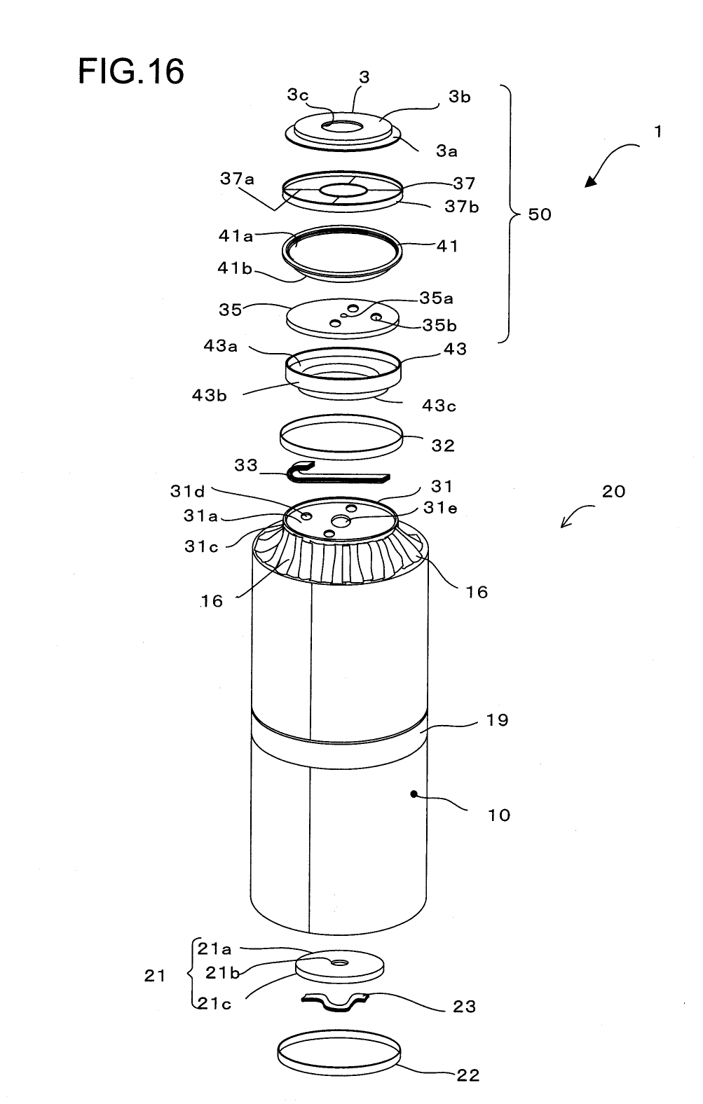

In the electrode assembly 10, the first separator 13, the negative electrode 12, the second separator 14, and the positive electrode 11 are layered and wound around the outer circumference of the winding core 15 in this order. It is to be noted that the innermost first separator 13 which contacts the outer circumference of the winding core 15 and the second separator 14 are wound through several turns (one turn in FIG. 17) inside the negative electrode 12 on the innermost circumference. In addition, the outermost circumference is provided with the negative electrode 12 the outer circumference of which is covered by the first separator 13. The first separator 13 on the outermost circumference is taped with an adhesion tape 19 (refer to FIG. 16).

The positive electrode 11, formed of aluminium foil, has an elongated shape and includes a positive-electrode sheet 11a and a positive-electrode processed portion, which has been prepared by coating a positive-electrode active material mix 11b on both sides of the positive-electrode sheet 11a. An upper side end in the winding axis direction of the positive-electrode sheet 11a is a positive-electrode active material mix unprocessed portion 11c, on which the positive-electrode active material mix 11b is not coated and the aluminium foil is left exposed. A multitude of positive-electrode leads 16 upwardly projecting in parallel with the winding core 15 are integrally formed at regular intervals on the positive-electrode active material mix unprocessed portion 11c.

The positive-electrode active material mix 11b is constituted with a positive-electrode active material, a positive-electrode conductive material, and a positive-electrode binder. The positive-electrode material is preferably lithium oxide such as lithium cobalt oxide, lithium manganate, lithium nickel oxide, and lithium complex oxide (lithium oxide containing two or more of cobalt, nickel, and manganese). Any positive-electrode conductive material may be used as long as it helps electrons having been generated by the occlusion and release reaction of lithium in the positive-electrode active material mix be transferred to the positive electrode. Examples of the positive-electrode conductive material include graphite and acetylene black.

The positive-electrode binder can bind the positive-electrode active material and the positive-electrode conductive material and also bind the positive-electrode active material mix and a positive-electrode current collector, and any positive-electrode binder may be used unless it degrades significantly due to contact with nonaqueous electrolytic solution. Examples of the positive-electrode binder include polyvinylidene fluoride (PVDF), and fluoro-rubber. Any method of forming the positive-electrode active material mix layer may be adopted as long as a positive-electrode active material mix is formed therewith on the positive electrode. Examples of a method of forming a layer of the positive-electrode active material mix 11b include a method to coat the dispersion solution of constituent of the positive-electrode active material mix 11b on the positive-electrode sheet 11a.

Examples of a method of coating the positive-electrode active material mix 11b on the positive-electrode sheet 11a include a roll coating method and a slit die coating method. A slurry, having been prepared by adding N-methylpyrrolidone (NMP), water, and the like, as examples of solvent of dispersion solution, to the positive-electrode active material mix 11b and mixing them, is coated uniformly on both sides of an aluminium foil of 20 μm thick, dehydrated, and then press cut. Coating thickness of the positive-electrode active material mix 11b is, for instance, approximately 40 μm on one side. When cutting the positive-electrode sheet 11a, the positive-electrode leads 16 are integrally formed.

The negative electrode 12, formed of copper foil, has an elongated shape and includes a negative-electrode sheet 12a and a negative-electrode processed portion, which has been prepared by coating a negative-electrode active material mix 12b on both sides of the negative-electrode sheet 12a. A lower end in the winding axis direction of the negative-electrode sheet 12a is a negative-electrode active material mix unprocessed portion 12c, on which the negative-electrode active material mix 12b is not coated and the copper foil is left exposed. A multitude of leads 17 extending in the opposite direction to the positive-electrode leads 16 are integrally formed at regular intervals on the negative-electrode active material mix unprocessed portion 12c.

The negative-electrode active material mix 12b is constituted with a negative-electrode active material, a negative-electrode binder, and a thickening agent. The negative-electrode active material mix 12b may include a negative-electrode conductive material such as acetylene black. It is preferable to use graphite carbon as the negative-electrode active material. The use of graphite carbon allows lithium-ion secondary cells for plug-in hybrid vehicles and electric vehicles that require a large capacity to be produced. Any method of forming the negative-electrode active material mix 12b may be adopted as long as the negative-electrode active material mix 12b is formed therewith on the negative-electrode sheet 12a. Examples of a method of coating the negative-electrode active material mix 12b on the negative-electrode sheet 12a include a method to coat the dispersion solution of constituent of the negative-electrode active material mix 12b on the negative-electrode sheet 12a. Examples of a method of coating include the roll coating method and the slit die coating method.

Examples of coating the negative-electrode active material mix 12b on the negative-electrode sheet 12a include a method in which a slurry, having been prepared by adding N-methyl-2-pyrrolidone and water, as dispersion solutions, to the negative-electrode active material mix 12b, is coated uniformly on both sides of a copper foil which has been rolled to 10 μm thick, dehydrated, and then press cut. Coating thickness of the negative-electrode active material mix 12b is, for example, approximately 40 μm on one side. When cutting the negative-electrode sheet 12a, the negative-electrode leads 17 are integrally formed.

Let the widths of the first separator 13 and the second separator 14 in the winding axis direction be denoted by WS, the width of the negative-electrode active material mix 12b formed on the negative-electrode sheet 12a in the winding axis direction be denoted by WC, and the width of the positive-electrode active material mix 11b formed on the positive-electrode sheet 11a in the winding axis direction be denoted by WA, the electrode plate material is formed so as to satisfy the following condition.

WS>WC>WA (refer to FIG. 17)

In other words, the width WC of the negative-electrode active material mix 12b is always greater than the width WA of the positive-electrode active material mix 11b. This is because, in a lithium-ion secondary cell, ionized lithium, which is a positive-electrode material, penetrates through the separator, and lithium may be precipitated on the negative-electrode sheet 12a, which may cause internal short-circuit if no negative-electrode material is formed on the negative-electrode sheet and the negative-electrode sheet 12b is exposed.

In FIG. 15 and FIG. 17, the hollow cylindrical winding core 15 is provided with a groove 15a, having a diameter larger than an inner diameter of the cylindrical winding core 15, formed on the inner surface of the upper end in the axis direction (vertical direction in the figures), and the positive-electrode current collecting member 31 is press fitted into the groove 15a. The positive-electrode current collecting member 31 is formed of, for instance, aluminium and includes a disk-shaped base 31a, a lower tube 31b, which is provided to form an inner circumference of the base 31a, protrudes towards the winding core 15 and is press fitted on the inner surface of the enter shaft 15, and an upper tube 31c, which protrudes towards the sealing cover 50 from the outer circumferential edge of the base 31a. An opening 31d is formed at the base 31a of the positive-electrode current collecting member 31 so as to release gas generated inside the cell.

All of the positive-electrode leads 16 of the positive-electrode sheet 11a are welded to the upper tube 31c of the positive-electrode current collecting member 31. In this case, as illustrated in FIG. 16, the positive-electrode leads 16 are joined on the upper tube 31c of the positive-electrode current collecting member 31 in an overlying manner. Each of the positive-electrode leads 16 alone is too thin to retrieve high current. For this reason, the multitude of positive-electrode leads 16 are formed at predetermined intervals throughout the entire length from the start to end of winding around the winding core 15.

The positive-electrode leads 16 of the positive-electrode sheet 11a and a ring-shaped retaining member 32 are welded on the outer circumference of the upper tube 31c of the positive-electrode current collecting member 31. With the multitude of positive-electrode leads 16 adhered on the outer circumference of the upper tube 31c of the positive-electrode current collecting member 31, the retaining member 32 is fitted around and temporarily fixed on the outer circumferences of the positive-electrode leads 16 and then welded in this state.

Since the positive-electrode current collecting member 31 is subjected to oxidization by the electrolytic solution, it is formed of aluminium so that reliability can be improved. When a surface of aluminium is exposed by a processing, an aluminium oxide film is immediately formed on the surface of the aluminium, and this aluminium oxide film prevents oxidation by electrolytic solution. In addition, the positive-electrode current collecting member 31 is formed of aluminium so as to allow the positive-electrode leads 16 of the positive-electrode sheet 11a to be welded by ultrasonic welding, spot welding, or the like.

A step 15b, having a diameter smaller than an outer diameter of the cylindrical winding core 15, is formed on the outer circumference of the lower end of the winding core 15, and the negative-electrode current collecting member 21 is press fitted and fixed to the step 15b. In the negative-electrode current collecting member 21, which is formed of, for example, copper, an opening 21b, which is to be press fitted to the step 15b of the winding core 15, is formed on a disk-shaped base 21a, and an outer circumference tube 21c, protruding toward the bottom side of the cell case 2, is formed at the outer circumference edge of the base 21a.

All of the negative-electrode leads 17 of the negative-electrode sheet 12a are welded to the outer circumference tube 21c of the negative-electrode current collecting member 21 by ultrasonic welding or the like. Since each of the negative-electrode leads 17 is very thin, a multitude of negative-electrode leads 17 are formed at predetermined intervals throughout the entire length from the start to end of winding around the winding core 15 so as to retrieve high current.

The negative-electrode leads 17 of the negative-electrode sheet 12a and a ring-shaped retaining member 22 are welded on the outer circumference of the outer circumference tube 21c of the negative-electrode current collecting member 21. With the multitude of the negative-electrode leads 17 adhered on the outer circumference of the outer circumference tube 21c of the negative-electrode current collecting member 21, the retaining member 22 is fitted around and temporarily fixed on the outer circumference of the negative-electrode leads 17 and then welded in this state.

A copper negative-electrode conducting lead 23 is welded on a lower surface of the negative-electrode current collecting member 21. The negative-electrode conducting lead 23 is welded to the cell case 2 at the bottom of the cell case 2. The cell case 2 is formed of, for instance, a carbon steel of 0.5 mm thick and is nickel-plated on its surface. Such material is used so as to allow the negative-electrode conducting lead 23 to be welded to the cell case 2 by resistance welding or the like.

A flexible positive-electrode conducting lead 33, constituted by layering a plurality of aluminium foils, is welded at its one end on the upper surface of the base 31 a of the positive-electrode current collecting member 31. The positive-electrode conducting lead 33 is prepared by layering and integrating the plurality of aluminium foils so that high current can be applied and the lead 33 can be flexible. More specifically, while it is necessary for a connection member to be thicker so as to apply high current, the connection member formed of a single metal plate has great rigidity, thereby losing the flexibility. The multitude of aluminium foils, which are less thick, are therefore layered for the flexibility. The positive-electrode conducting lead 33 is, for instance, approximately 0.5 mm thick, which are formed by layering five aluminium foils of 0.1 mm thick.

As explained above, the multitude of positive-electrode leads 16 are welded to the positive-electrode current collecting member 31 and the multitude of negative-electrode leads 17 are welded to the negative-electrode current collecting member 21 so as to constitute the discharge and charge unit 20 in which the positive-electrode current collecting member 31, the negative-electrode current collecting member 21, and the electrode assembly 10 are integrated as a unit (refer to FIG. 16). In FIG. 16, however, the negative-electrode current collecting member 21, the retaining member 22, and the negative-electrode conducting lead 23 are illustrated separately from the discharge and charge unit 20 for the sake of convenience of illustration.

(Sealing Cover 50)

The sealing cover 50 will be explained in detail with reference to FIG. 15 and FIG. 16.

The sealing cover 50, which is pre-assembled as a sub-assembly, includes a cap 3, which has an exhaust port 3c, a cap casing 37, which is attached to the cap 3 and has cleavage grooves 37a, a positive-electrode insulation ring 41, which has been spot welded on the back side at the center of the cap casing 37, and a connecting plate 35, which is to be sandwiched between the circumferential upper surface of the positive-electrode insulation ring 41 and the back side of the cap casing 37.

The cap 3 is formed by nickel-plating iron such as carbon steel. The cap 3, which has a hat-like shape as a whole, includes a disk-shaped circumferential portion 3a and a head 3b, which protrudes upwardly from the circumferential portion 3a. The head 3b is provided with an opening 3c formed at the center thereof The head 3b functions as a positive-electrode external terminal, to which a bus bar or the like are connected.

The circumferential portion 3a of the cap 3 is integrated with a turned flange 37b of the cap casing 37 formed of aluminium alloy. In other words, the circumference of the cap casing 37 is turned down along the upper side of the cap 3 so as to crimp-fix the cap 3. The circle formed by being turned down on the upper side of the cap 3, i.e., the flange 37b, and the cap 3 are friction welded. In other words, the cap casing 37 and the cap 3 are integrated by crimp-fixing and welding the flange 37b.

The circular-shaped cleavage groove 37a and the cleavage grooves 37a which extend radially in four directions from the circular cleavage groove 37a are formed in the central circular area of the cap casing 37. The cleavage grooves 37a are prepared by pressing and crushing the upper side of the cap casing 37 into a V-shape and leaving the remaining portions thin. When internal pressure in the cell case 2 rises over a predetermined value, the cleavage grooves 37a are cleaved so as to release the internal gas.

The sealing cover 50 constitutes an explosion proof mechanism. When the internal pressure of the cell case 2 exceeds a reference value due to gas generated inside the cell case 2, the cap casing 37 are cracked at the cleavage grooves 37a and the internal gas is released through the exhaust port 3c of the cap 3, thereby reducing the pressure in the cell case 2. In addition, the internal pressure of the cell case 2 causes the cap casing 37, which is also called as a diaphragm, to bulge outward the case, so that electrical connection with the positive-electrode insulation ring 41 is disconnected, thereby reducing overcurrent.

The sealing cover 50 is placed on the upper tube 31c of the positive-electrode current collecting member 31 in an insulated state. In other words, the cap casing 37 with which the cap 3 is integrated is placed on the upper end surface of the positive-electrode current collecting member 31 through the insulating ring 41 in an insulated state. The cap casing 37 is electrically connected to the positive-electrode current collecting member 31 through the positive-electrode conducting lead 33, and the cap 3 of the sealing cover 50 constitutes the positive electrode of the cell 1. Here, the insulating ring 41 includes an opening 41a (refer to FIG. 16) and a side portion 41b, which protrudes downward.

The connecting plate 35, formed of aluminium alloy, has a substantially dish-like shape in which a substantially entire area except a central area is uniform and the central area is deflected slightly low. The connecting plate 35 is, for example, approximately 1 mm thick. A thin, dorm-shaped protrusion 35a is formed at the center of the connecting plate 35, and a plurality of openings 35b (refer to FIG. 16) are formed around the protrusion 35a. The openings 35b include a function to release gas generated inside the cell. The protrusion 35a of the connecting plate 35 is welded to the bottom of the center of the cap casing 37 by resistance welding or friction diffusion welding.

The electrode assembly 10 is housed in the cell case 2, and the sealing cover 50, which has been pre-produced as a sub-assembly, is electrically connected to the positive-electrode current collecting member 31 through the positive-electrode conducting lead 33 and placed on the upper part of the cylinder. Then, an outer circumference wall 43b of the gasket 43 is bent by pressing or the like and the sealing cover 50 is crimped with a base 43a and the outer circumference wall 43b so that the sealing cover 50 is axially pressure welded. As a result, the sealing cover 50 is fixed to the cell case 2 through the gasket 43.

The gasket 43 initially has a shape which includes, as illustrated in FIG. 16, the outer circumference wall 43b, which is erected substantially vertically upward on the circumferential side edge of the ring-shaped base 43a, and, in the inner circumference side, a tube 43c, which is dropped substantially vertically downward from the base 43a. The cell case 2 is crimped so that the sealing cover 50 is held in the cell case 2 through the outer circumference wall 43b.

A predetermined amount of nonaqueous electrolytic solution is inlet inside the cell case 2. As an example of nonaqueous electrolytic solution, it is preferable to use a solution in which lithium salt is dissolved in carbonate solvent. Examples of the lithium salt include lithium fluorophosphate (LiPF₆) and lithium borofluoride (LiBF₆). In addition, examples of carbonate solvent include ethylene carbonate (EC), dimethyl carbonate (DMC), propylene carbonate (PC), and methyl ethyl carbonate (MEC), and mixture of two or more of the above solvents may also be used.

The second embodiment achieves operations and advantageous effects similar to those achieved by the first embodiment.

The present invention is applied to all lithium-ion secondary cells including a winding electrode assembly in which a metal current collector body is provided with an active material mix layer and an exposed area, regardless of presence of a winding core.

Therefore, the present invention can be applied to a variety of lithium-ion secondary cells which include a winding electrode assembly that comprises: a positive-electrode plate in which a positive-electrode active material mix layer is disposed on both sides of a positive-electrode metal current collector body and an exposed area of the positive-electrode metal current collector body is provided along one of long sides of the positive-electrode plate; a negative-electrode plate in which a negative-electrode active material mix layer is disposed on both sides of a negative-electrode metal current collector body and an exposed area of the negative-electrode metal current collector body is provided along one of long sides of the negative-electrode plate; and a separator arranged between the positive-electrode plate and the negative-electrode plate, wherein: the exposed area of the positive-electrode metal current collector body is formed at one end in a winding axis direction of the winding electrode assembly, and the exposed area of the negative-electrode metal current collector body is formed at another end in the winding axis direction of the winding electrode assembly; and the negative-electrode metal current collector body is a copper foil rolled to a thickness between 6 μm and 15 μm in which one or more of additive elements of Zr, Ag, Au, Pt, Cr, Cd, Sn, Sb, and Bi are added to Cu having a purity of equal to or greater than 99.9%, and the negative-electrode active material mix layer has a cavity volume ratio of between 30% and 60%.

The longer an electrode plate is, the more effective the present invention is. A lithium-ion secondary cell according to the present invention is primarily used as a large lithium-ion secondary cell for a hybrid vehicle, an electric vehicle, a backup power supply (UPS: Uninterruptible Power Supply), and the like. In other words, it is preferable to use the present invention for a lithium-ion secondary cell of a few (approximately 2 to 3) Ah to several dozen Ah. This is because a small cell of, e.g., less than a few (approximately 2 to 3) Ah, does not suffer so much from a problem of fan deformation in the current collector body production process described above.

The above described embodiments are examples, and various modifications can be made without departing from the scope of the invention.

What is claimed is:

1. A lithium-ion secondary cell, comprising:
winding electrode assembly that comprises:
positive-electrode plate in which a positive-electrode active material mix layer is disposed on both sides of a positive-electrode metal current collector body and an exposed area of the positive-electrode metal current collector body is provided along one of long sides of the positive-electrode plate;
negative-electrode plate in which a negative-electrode active material mix layer is disposed on both sides of a negative-electrode metal current collector body and an exposed area of the negative-electrode metal current collector body is provided along one of long sides of the negative-electrode plate; and
separator arranged between the positive-electrode plate and the negative-electrode plate, wherein:
the exposed area of the positive-electrode metal current collector body is formed at one end in a winding axis direction of the winding electrode assembly, and the exposed area of the negative-electrode metal current collector body is formed at another end in the winding axis direction of the winding electrode assembly; and
the negative-electrode metal current collector body is a copper foil rolled to a thickness between 6 μm and 15 μm in which one or more of additive elements of Zr, Ag, Au, Pt, Cr, Cd, Sn, Sb, and Bi are added to Cu having a purity of equal to or greater than 99.9%, and the negative-electrode active material mix layer has a cavity volume ratio of between 30% and 60%.

2. A lithium-ion secondary cell according to claim 1, wherein:
the exposed area of the positive-electrode metal current collector body is between 1 mm and 20 mm wide in the winding axis direction, and the exposed area of the negative-electrode metal current collector body is between 1 mm and 20 mm wide in the winding axis direction .

3. A lithium-ion secondary cell according to claim 1, wherein:
the negative-electrode metal current collector body is formed by rolling oxygen-free copper.

4. A lithium-ion secondary cell according to claim 1, wherein:
the winding electrode assembly is flat-shaped, and the flat-shaped winding electrode assembly is housed in a flat prismatic cell case.

5. A lithium-ion secondary cell according to claim 1, wherein:
the winding electrode assembly is cylindrical-shaped, and the cylindrical-shaped winding electrode assembly is housed in a cylindrical cell case.
